(19) United States
(12) Patent Application Publication
(10) Pub. No.: US 2023/0176007 A1
(43) Pub. Date: Jun. 8, 2023

(54) Sensor With Integral Seal

(71) Applicant: Therm-O-Disc, Incorporated, Mansfield, OH (US)

(72) Inventors: Jeffrey A. WEST, Bellville, OH (US); Richard Eugene GARRISON, Bellville, OH (US)

(73) Assignee: Therm-O-Disc, Incorporated, Mansfield, OH (US)

(21) Appl. No.: 17/957,706

(22) Filed: Sep. 30, 2022

Related U.S. Application Data
(60) Provisional application No. 63/285,211, filed on Dec. 2, 2021.

(51) Int. Cl. G01N 27/407; G01N 27/406

(52) U.S. Cl. CPC G01N 27/4078; G01N 27/4062; H01B 17/308

(57) ABSTRACT

A sensor includes a sensing element, a first pair of lead wires, a second pair of lead wires, a grommet, and a shell. The first pair of lead wires is fixed to the sensing element and configured to receive signals from the sensing element. The second pair of lead wires is electrically connected to the first pair of lead wires at a joint. The second pair of lead wires is configured to receive signals from the first pair of lead wires. The grommet houses the joint, a portion of the first pair of lead wires, and a portion of the second pair of lead wires. The shell houses the sensing element, the first pair of lead wires, and the grommet. The shell engages and deforms the grommet to seal an interior space defined by the shell.

### CROSS-REFERENCE TO RELATED APPLICATION

This application claims the benefit of U.S. Provisional Application No. 63/285,211, filed on Dec. 2, 2021. The entire disclosure of the above application is incorporated herein by reference.

### FIELD

The present disclosure relates to a sensor construction and, more particularly, to a thermistor-type temperature sensor having an integral sealing grommet.

### BACKGROUND

This section provides background information related to the present disclosure which is not necessarily prior art.

Sensors are used in many household appliances and commercial applications, including refrigeration systems and heating, ventilating and air conditioning (HVAC) systems to measure various parameters of the ambient environment, such as, for example, temperature. Temperature sensors often include thermistor temperature sensors, which provide a change in resistance with a change in temperature. Thermistor temperature sensors can form part of an electronic circuit to measure temperature in a system over a wide range.

Thermistor temperature sensors often include a sensing element positioned within a thermally-conductive housing. Typically, a potting material, such as an epoxy, is applied to fill the housing and surround and secure the sensing element.

### SUMMARY

This section provides a general summary of the disclosure, and is not a comprehensive disclosure of its full scope or all of its features.

A sensor includes a sensing element, a first pair of lead wires, a second pair of lead wires, a grommet, and a shell. The first pair of lead wires is fixed to the sensing element and configured to receive signals from the sensing element. The second pair of lead wires is electrically connected to the first pair of lead wires at a joint. The second pair of lead wires is configured to receive signals from the first pair of lead wires. The grommet houses the joint, a portion of the first pair of lead wires, and a portion of the second pair of lead wires. The shell houses the sensing element, the first pair of lead wires, and the grommet. The shell engages and deforms the grommet to seal an interior space defined by the shell.

The present disclosure describes a temperature sensor. In one aspect of the disclosure, the sensor includes a housing comprising a deformable tubular shell having a closed distal end, an open proximal end and a side wall, and defining an interior cavity. A temperature responsive sensing element having first and second sensing element lead wires is disposed in the interior cavity. First and second sensor lead wires are each electrically connected in series to a respective one of the first and second sensing element lead wires. A grommet made from a flexible and resilient dielectric material and having an outer annular surface encapsulates the first and second connections. The grommet, the sensing element, the first and second sensing element lead wires, and the first and second connections are disposed in the interior cavity of the housing. The side wall of the housing is mechanically interlocked to the grommet at the outer surface of the grommet to seal the sensing element and sensing element lead wires from an ambient environment outside the interior cavity of the housing.

In another aspect, the temperature sensor side wall includes a roll-form crimp that locally deforms the outer surface of the grommet and creates a circumferential compression seal between the housing and the grommet that isolates the sensing element and the sensing element lead wires from the ambient environment.

In still another aspect, the first connection and the second connection are disposed in a staggered relationship to one another.

In still another aspect, the grommet includes a void that is located between the first connection and the second connection.

In yet another aspect, the outer surface of the grommet includes a plurality of annular protrusions spaced apart from one another along a longitudinal axis of the grommet. An outer dimension of each of the protrusions is greater than an inner dimension of the side wall.

Still another aspect of the disclosure, at least a portion of the first and second sensing element lead wires and the first and second sensor lead wires are encapsulated by the grommet.

Still further, the housing includes an inwardly directed flange at the proximal end of the housing. The inwardly directed flange abuts an end of the grommet. The inwardly directed flange retains the grommet with the housing.

In yet another aspect of the disclosures, the sensing element is spaced from the side wall of the housing. Further, the sensing element is spaced from the distal end of the housing. Alternatively, the sensing element is in direct contact with the distal end of the housing. Each of the first and second sensing element lead wires can include a loop.

In another aspect of the disclosure, the sensor includes a thermally conductive dielectric epoxy disposed in the interior cavity of the housing near the distal end of the housing and encapsulating the sensing element and at least a portion of the first and second sensing element lead wires.

In yet another aspect, the housing comprises an outwardly directed flange forming a circumferential lip at the proximal end of the housing. Further, the housing includes a first portion and a second portion. The first portion of the housing can include at least one annular channel that extends around a circumference of the side wall. The is mechanically interlocked to the grommet at the at least one annular channel. The sensing element is disposed in the second portion of the housing.

Still further, the grommet can include a first portion and a second portion. The first portion of the grommet has a first diameter and a resilient and flexible first annular protrusion. The second portion of the grommet has a second diameter and a resilient and flexible second annular protrusion. The second diameter is less than the first diameter. Also, both the first annular protrusion and the second annular protrusion have a third diameter that is greater than the first diameter.

In still another aspect of the disclosure, one of the outer surface of the grommet and an inner surface of the side wall includes a plurality of longitudinally extending linear guide rails spaced apart from one another. The other of the outer surface of the grommet and the inner surface of the side wall has a corresponding plurality of longitudinally extending linear grooves spaced apart from one another. Each of the guide rails is received in a corresponding one of the grooves.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of an example thermistor sensor according to the present disclosure.

FIG. 2 is a partially-exploded front view of the sensor of FIG. 1 showing a cover removed from a sensing element.

FIG. 3 is an enlarged, detail view in cross-section, of a portion of the sensor of FIG. 1 taken at boundary A.

FIG. 4 is a cross-sectional view of another example of a sensor according to the present disclosure.

FIG. 5 is a partial cross-sectional view of a portion of another configuration of a sensor according to the present disclosure.

FIG. 6 is a cross-sectional view of an alternate grommet for use with the sensor in FIG. 4.

FIG. 7 is a partial cross-sectional view of another example sensor according to the present disclosure.

FIG. 8 is a front-top-left perspective view of a grommet for the sensor in FIG. 7.

FIG. 9 is a rear-top-right perspective view of the grommet in FIG. 8.

FIG. 10 is a perspective view of an alternative configuration of the grommet in FIG. 8.

FIG. 11 is another perspective view of the grommet in FIG. 10.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

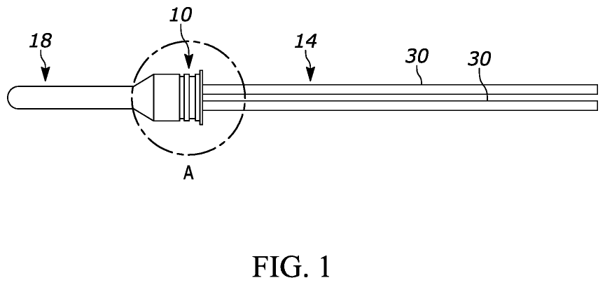

Referring to FIG. 1, a sensor 10 according to the present disclosure is shown. The sensor 10 may be a thermistor temperature sensor configured for use, for example, in an appliance, refrigeration system, or HVAC system. Alternatively, the sensor 10 may be any suitable sensor for use in any suitable system.

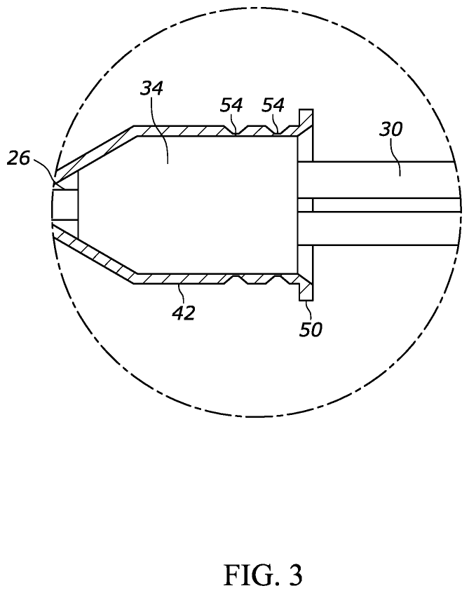

As understood with reference to FIGS. 1 and 3, the sensor 10 may be a two-piece construction that includes a sensor probe 14 and a shell housing or cover 18. The shell housing or cover 18 may fit over a distal end of the sensor probe 14.

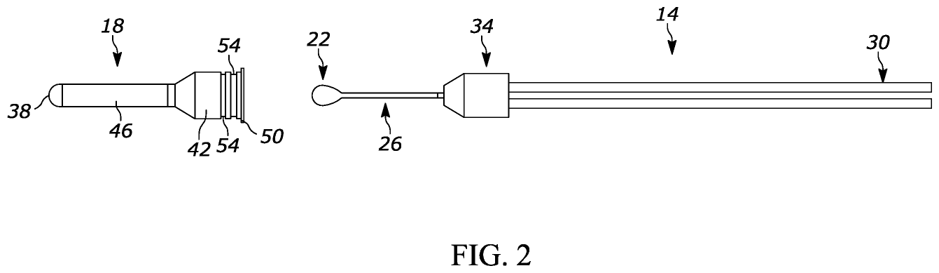

Referring to FIG. 2, the sensor probe 14 may include a sensing element 22 having sensing element lead wires 26 in electrical communication with sensor lead wires 30. The sensing element 22 may include a suitable resistor that exhibits change in electrical resistance with a change in a measured parameter. For example, the sensing element 22 may be a temperature-responsive element, such as a thermistor, that is thermally sensitive and exhibits a change In electrical resistance with a change in its temperature. Alternatively, the sensing element 22 may be responsive to a parameter other than temperature.

The sensing element lead wires 26 may be joined to the sensing element 22, respectively, on opposite sides of the sensing element 22. The sensing element lead wires 26 may be formed of metal or another electrically conductive material. The sensing element lead wires 26 may be joined to the sensing element 22, for example, by soldering or any other suitable method.

The sensor lead wires 30 electrically connect to the sensing element lead wires 26 and may include terminal connectors that project from their respective proximal ends. The sensor lead wires 30 can serve to electrically connect or integrate the sensor 10 within, for example, a control circuit (not shown) of an appliance, refrigeration system or HVAC system. For example, a control circuit can measure or determine a resistance and/or change in resistance over time across the sensing element 22 by way of the sensor lead wires 30. The resistance and/or change in resistance can be interpreted by a controller (not shown) of the control circuit. The sensor lead wires 30 may be formed of metal or another conductive material and may be joined to the sensing element lead wires 26, for example, by soldering or any other suitable method.

An electrically-insulating covering may be formed over the connections between the sensor lead wires 30 and the sensing element lead wires 26. For example, the electrically-insulating covering may take the form of a generally cylindrically-shaped grommet 34 having a tapering cone-shaped portion at a leading or distal end as shown in FIG. 2. The grommet 34 may be molded-in-place over the connections after the connections are made between the sensor lead wires 30 and the sensing element lead wires 26.

The grommet 34 may electrically insulate the electrical connections between the sensor lead wires 30 and the sensing element lead wires 26 from one another. Additionally, the housing 18 may be crimped (or otherwise mechanically interlocked) to the grommet 34 (as described below) to seal, isolate and protect the sensing element 22 and the sensing element lead wires 26 from the ambient environment.

The grommet 34 may be formed from a flexible and resilient dielectric material, such as an elastomer (e.g., rubber) or a thermoplastic. By forming the grommet 34 from a flexible and resilient material, the grommet 34 is able to deform and mold into and around the contours of the housing 18 when the housing 18 is crimped, deformed or otherwise mechanically interlocked to the grommet 34 to provide a robust seal from the ambient environment, and helping to inhibit or prevent dirt, debris, moisture and air, etc., from infiltrating the sensor 10 and/or affecting the function or performance of the sensing element 22 and/or the electrical connections between the sensing element 22 and the sensing element lead wires 26.

The housing 18 may take the form of a housing or shell having a tubular construction and closed off at a distal end 38. The housing 18 may be a metal (such as aluminum, for example) or other material that can be deformed or crimped to interlock and/or fit closely and securely around the grommet 34, as described below. The housing 18 is preferably thermally conductive.

The housing 18 may include a proximal, large diameter portion 42 and a distal, small diameter portion 46. The large diameter portion 42 may have a size and shape and define an internal space that corresponds to a size and shape of the grommet 34. The large diameter portion 42 may have a diameter slightly larger (for example, 1-5% larger) than a diameter of the grommet 34, such that the grommet 34 may be received within the internal space defined by the large diameter portion 42, preferably without interference to ease assembly of the components (as further described herein). The small diameter portion 46 may have a diameter slightly larger (for example, 2-10% larger) than a width of the sensing element 22, such that the sensing element 22 and sensing element lead wires 26 may be received within the internal space defined by the small diameter portion 46.

The housing 18 may include a lip 50 on a proximal end of the cover 18. The lip 50 may increase in diameter from the large diameter portion 42, e.g., the lip 50 may form an outwardly extending flange at the proximal end of the cover 18. A pair of annular grooves or channels 54 may extend around an outer circumferential surface 58 of the large diameter portion 42. The channels 54 may define a location where the housing 18 may be mechanically deformed (such as by crimping) to interlock with and/or seal against the grommet 34 during assembly of the sensor 10 to isolate the sensing element 22 and sensing element lead wires 26 from the ambient environment. The channels 54 may further be mating features that align the housing 18 on the grommet 34 during assembly and prior to deforming the cover 18.

A preferred method of manufacture of the sensor 10 according to the present disclosure can be described as follows. The sensing element lead wires 26 are electrically connected to the sensor lead wires 30. Thereafter, the grommet 34 is molded-in-place over the electrical connection between sensing element lead wires 26 and the sensor lead wires 30 to form the sensor probe 14 subassembly. The sensor probe 14 is inserted into the internal space of the housing 18 along the direction of the longitudinal axis of the cover 18. After insertion of the sensor probe 14, the sensing element 22, the sensing element lead wires 26 and grommet 34 are all disposed within the internal space defined by the housing 18 and with the sensor lead wires 30 extending outward from the internal space. As illustrated in FIGS. 2 and 3, the grommet 34 fits within the large diameter portion 42, and the lip 50 of the large diameter portion 42 extends past the proximal end of the grommet 34. The large diameter portion 42 of the housing 18 is crimped or mechanically deformed at the location of the channels 54 to snugly engage the grommet 34 about the proximal end of the housing 18 defined by the lip 50 and to sealingly isolate the sensing element 22 and sensing element lead wires 26 within the housing 18 and from the ambient environment.

The sealing closure provided by the grommet 34 and housing 18 provides an improved sensor 10. The sealing closure improves the manufacture and performance of the sensor 10. Where previous sensors used epoxy or adhesive, the crimped cover 18, grommet 34, and fixed connection between the sensing element lead wires 26 and sensor lead wires 30 of the present disclosure provides a more robust, mechanical connection that is less fragile and less prone to failure. Where previous manufacture required application and setting of epoxy, adhesive, or other potting material, the crimped housing 18 and grommet 34 are easily assembled and crimped without potting, providing an manufacturing method that is readily repeatable and less likely to deviate. Additionally, the grommet 34 eliminates the need for shrink tube electrical insulators to be applied on the sensor 10 assembly by providing a seal and insulator to the internal space housing the sensing element 22 and sensing element lead wires 26. Because shrink tube electrical insulators and potting materials are eliminated, the manufacture of the sensor 10 may be readily automated, providing a cost reduction and other manufacturing process improvements.

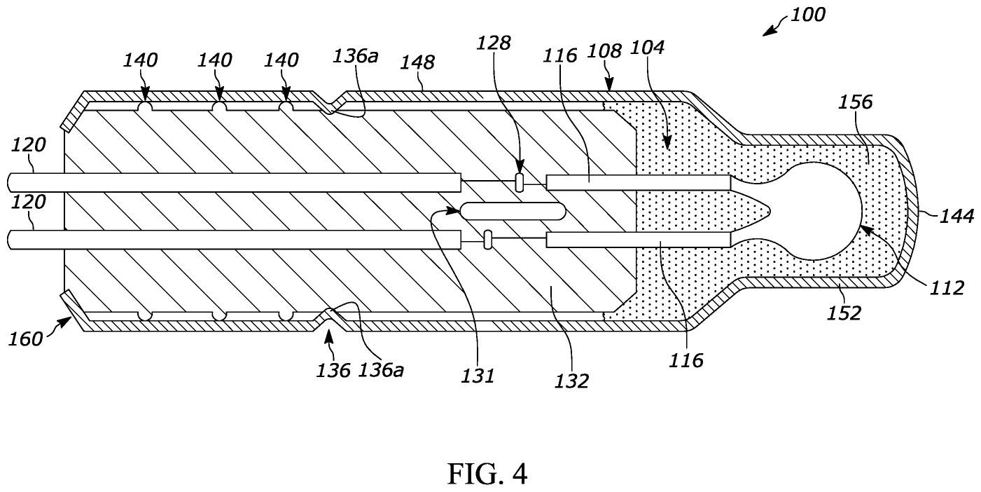

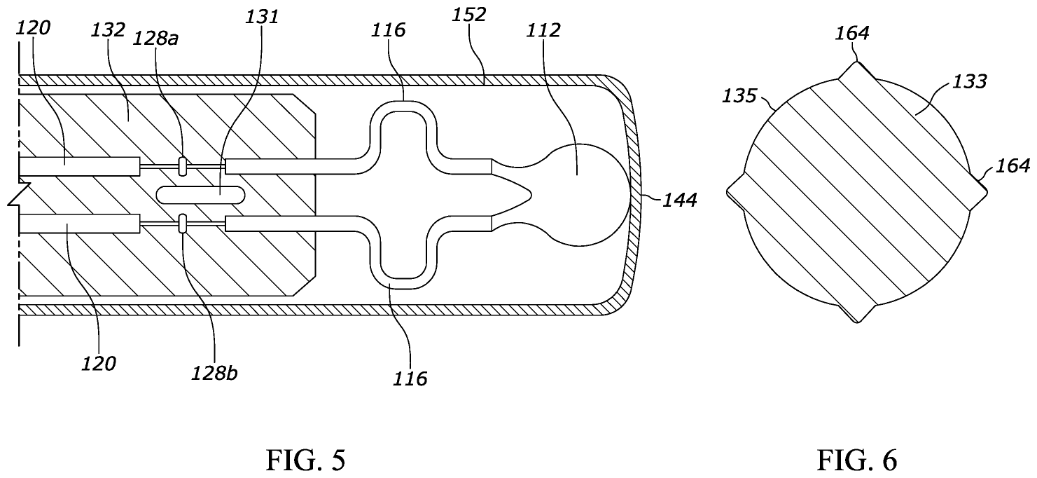

Now referring to FIGS. 4 and 5, a sensor 100 according to the present disclosure is shown. The sensor 100 may be similar to sensor 10. The sensor 100 may be a thermistor temperature sensor configured for use in an appliance, a refrigeration system or a HVAC system. Alternatively, the sensor 100 may be any suitable sensor for use in any suitable system.

Sensor 100 may be a two-piece sensor that includes a sensor probe 104 and a shell housing or cover 108. The shell housing or housing 108 may fit over a distal end of the sensor probe 104.

The sensor probe 104 may include a sensing element 112 having sensing element lead wires 116 in electrical communication with sensor lead wires 120. The sensing element 112 may include a suitable resistor that exhibits change in electrical resistance with a change in a measured parameter. For example, the sensing element 112 may be a temperature-responsive element, such as a thermistor, that is thermally sensitive and exhibits a change in electrical resistance with a change in its temperature. Alternatively, the sensing element 112 may be responsive to a parameter other than temperature.

The sensing element 112 may include an epoxy coating. The epoxy coating may provide a sealing barrier to isolate the sensing element 112 from moisture, dirt, debris, etc. The epoxy coating may additionally provide physical protection and add electrical insulation to the sensing element 112.

The sensing element lead wires 116 may be joined to the sensing element 112, respectively, on opposite sides of the sensing element 112. The sensing element lead wires 116 may be formed of metal or another conductive material. The sensing element lead wires 116 may be joined to the sensing element 112, for example, by soldering or any other suitable method.

The sensor lead wires 120 electrically connect to the sensing element lead wires 116 and may include a pair of terminal connectors that project from their respective proximal ends. The sensor lead wires 120 can serve to electrically connect or integrate the sensor 100 within, for example, a control circuit (not shown) of an appliance, refrigeration system or HVAC system. For example, a control circuit can measure or determine a resistance and/or change in resistance over time across the sensing element 112 by way of the sensor lead wires 120. The resistance and/or change in resistance can be interpreted by a controller (not shown) of the control circuit. The sensor lead wires 120 may be formed of metal or another conductive material and may be joined to the sensing element lead wires 116, for example, at a connection 128. For example, the connection 128 may be formed by soldering, automatic splicing, fountain soldering, connectors, or any other suitable method. The connection 128a of one sensor lead wire 120 may be staggered from the connection 128b of another sensor lead wire 120.

An electrically-insulating covering may be formed over and house the connections 128a, 128b between the sensor lead wires 120 and the sensing element lead wires 116. For example, the electrically-insulating covering may take the form of a generally cylindrically-shaped grommet 132. The grommet 132 may be molded-in-place over the connections 128a, 128b after the connections 128a, 128b are made between the sensor lead wires 120 and the sensing element lead wires 116. Alternatively, or in addition, the connections 128a, 128b of the sensor lead wires 120 may be separated by a void or retracting core 131 in the grommet 132.

The grommet 132 may electrically insulate the sensor lead wires 120 from one another. The grommet 132 may also electrically insulate the connections 128a, 128b from one another. For example, with reference to FIGS. 4 and 5, the grommet 132 may extend over the sensor lead wires 120 and the connections 128a, 128b. Additionally, the housing 108 may be mechanically deformed (such as by crimping as further described below) to interlock with and/or seal, isolate and protect the sensing element 112 and the sensing element lead wires 116 from the ambient environment.

Alternatively, the grommet 132 may be formed over the sensor lead wires 120 but not the connections 128a, 128b.

The grommet 132 may be formed from a flexible and resilient dielectric material, such as an elastomer (e.g., rubber or polypropylene) or a thermoplastic sealing material (e.g., polyvinyl chloride (PVC)). By forming the grommet 132 from a flexible and resilient material, the grommet 132 is able to deform and mold into and around the contours of the housing 108 when the housing 108 is mechanically deformed (e.g., crimped) to provide a seal. As seen in FIG. 4, the housing 108 can include a crimp 136 that forms a robust circumferential compression seal 136a with the grommet 132 to help inhibit or prevent dirt, debris, moisture, air, etc., from the ambient environment infiltrating the sensor 100 and/or affecting the function or performance of the sensing element 112 and/or the electrical connections 128a, 128b with the sensing element lead wires 116.

As best seen in FIG. 4 6, the grommet 132 may include one or more annular protrusions or ribs 140 formed around a circumference of the grommet 132. Multiple protrusions 140 may be spaced apart along a longitudinal axis of the grommet 132. The protrusions 140 may engage an inner surface of the housing 108 to provide additional or redundant seals between the housing 108 and grommet 132 to further isolate the sensing element 112 and the sensing element lead wires 116. For example, protrusions 140 may provide serve the function of O-ring-type seals in addition to the compression seal created at the crimp 136. The protrusions 140 may be formed integrally and monolithically with the grommet 132 such that the protrusions 140 are also flexible and resilient and able to deform against the housing 108 to seal the sensing element 112 and the sensing element lead wires 116 from the ambient environment.

The housing 108 may take the form of a housing or shell having a tubular construction and closed off at a distal end 144. The housing 108 may be a metal (such as aluminum, for example), a plastic, or other material that can be deformed or crimped to fit closely and securely around the grommet 132 as described herein. The housing 18 may also be thermally conductive.

The housing 108 may include a proximal, large diameter portion 148 and a distal, small diameter portion 152. The large diameter portion 148 may have a size and shape and define an internal space that corresponds to a size and shape of the grommet 132. The large diameter portion 148 may have a diameter slightly larger (for example, 1-5% larger) than a diameter of the grommet 132, such that the grommet 132 may be received within the internal space defined by the large diameter portion 148 without causing air compression when the grommet 132 is inserted. The small diameter portion 152 may have a diameter slightly larger (for example, 2-10% larger) than a width of the sensing element 112, such that the sensing element 112 and sensing element lead wires 116 may be received within the internal space defined by the small diameter portion 152.

A thermally-conductive, heat transfer compound 156 may be provided to fill the internal space defined by the small diameter portion 152 between the housing 108 and the sensing element 112 and between the housing 108 and the exposed portions of the sensing element lead wires 116. For example, the heat transfer compound 156 may be a dielectric epoxy or another suitable compound. The heat transfer compound 156 may support the sensing element 112 and sensing element lead wires 116 within the small diameter portion 152 and may provide heat transfer from the housing 108 or the atmosphere surrounding the housing 108 to the sensing element 112.

The housing 108 may include an inwardly extending (i.e., relative to the longitudinal axis of the housing 108) retaining flange 160 at the extreme proximal end of the housing 108. The retaining flange 160 may abut against the grommet 132 to retain the grommet 132 within the housing 108 to inhibit or prevent the grommet 132 from becoming dislodged or separated from the housing 108 after manufacture of the sensor 100. The retaining flange 160 may engage the grommet 132 such that the housing 108 abuts directly against the end of the grommet 132 such that there is no space or separation between the housing 108 and the grommet 132.

During manufacture of the sensor 100, the heat transfer compound 156 is dispensed into the distal, small diameter portion 152 of the housing 108. The sensor probe 104 (i.e., the subassembly of the sensing element 112, sensing element lead wires 116, the sensor lead wires 120 and over-molded grommet 132) is inserted into the internal space defined by the housing 108 until the distal end of the sensor probe 104 is submersed in the heat transfer compound 156 and the grommet 132 is located fully inside the cover 108.

The sensing element 112 may be positioned such that a gap between the sensing element 112 and housing 108 surrounds the sensing element 112 on all sides, as shown in FIG. 4. Preventing the sensing element 112 from contacting the housing 108 promotes more uniform heat transfer from the ambient environment through the thermally conductive cover and heat transfer compound to the sensing element 112 and enables the sensor 100 to be less sensitive to the influences of temperature spikes.

Alternatively, the sensing element 112 may be positioned such that a gap exists between the sensing element 112 and the housing 108 about a circumference of the sensing element 112 but that the sensing element 112 contacts or engages the housing 108 at an extreme distal end or tip of the sensing element 112, such as shown in FIG. 5. When the sensing element 112 contacts the housing 108 in this manner, the distance between the sensing element 112 and the grommet 132 may be reduced, such as by bending or looping the sensing element lead wires 116 as illustrated in FIG. 5. Placing the distal tip of the sensing element 112 in contact with the housing 108 can produce a sensor 100 more sensitive to ambient temperature changes and/or having a faster thermal response.

Regardless of the positioning of the sensing element 112 in the small diameter portion 152, the grommet 132 fits within the large diameter portion 148 of the housing 108 and the retaining flange 160 is formed at the proximal end of the large diameter portion 42 to engage the grommet 132. The large diameter portion 148 can include the crimp 136 that locally deforms the grommet 132 and creates a circumferential compression seal 136a between the housing 108 and the outer surface of the grommet 132 to help seal, isolate and protect the sensing element 112 and the sensing element lead wires 116 from the ambient environment.

The closed, sealed construction of the sensor 100 improves the manufacturability and performance response of the sensor 100. The deformed or crimped housing 108, grommet 132, and fixed connection between the sensing element lead wires 116 and sensor lead wires 120 of the present disclosure provides a more robust, mechanical connection that is less fragile and less prone to failure as compared with previous designs that only used a potting mixture between the wiring and shell. Additionally, the grommet 132 eliminates the need for shrink tube electrical insulators to be applied to the sensor 100 assembly.

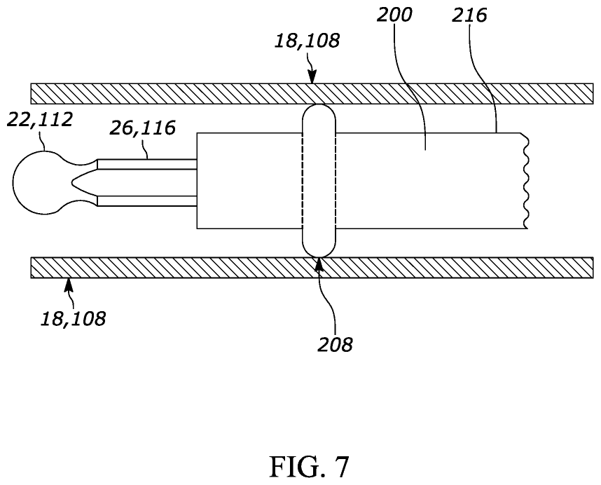

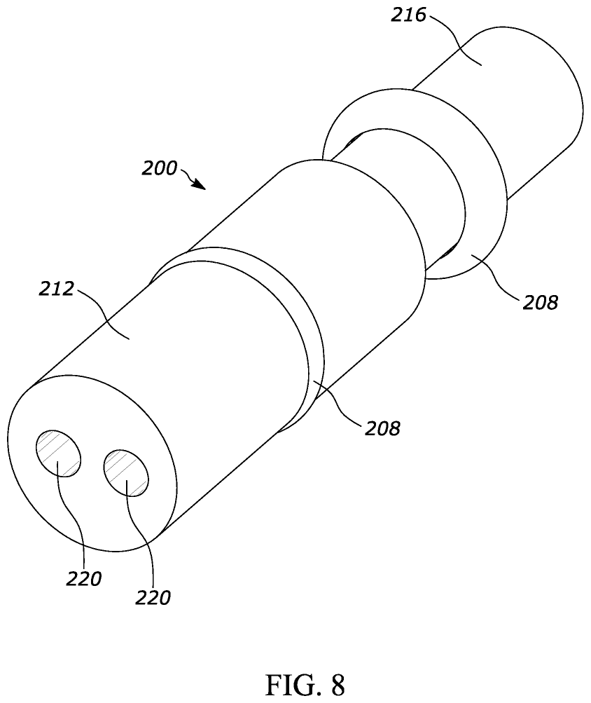

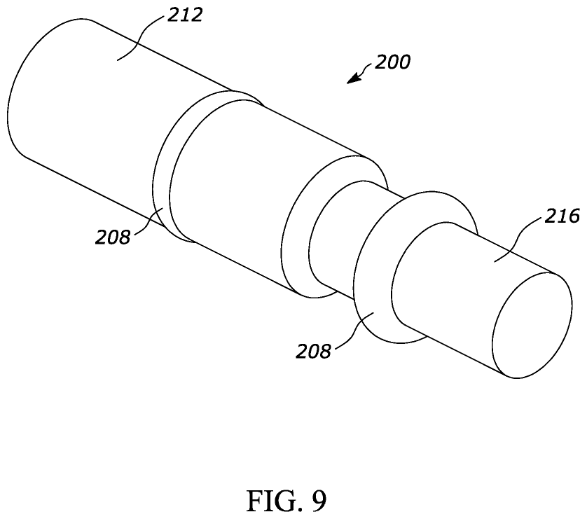

Referring to FIGS. 7-9, an alternative grommet 200 for the sensor 10 or the sensor 100 is illustrated. The grommet 200 may house and provide dielectric insulation for the electrical connections between the sensing element lead wires 26, 116 and the sensor lead wires 30, 120. As shown in the Figures, the grommet 200 may include a body 204 and one or more integral, raised, annular ribs or protrusions 208. The grommet 200 may be housed within the cover 18, 108 and the protrusion 208 is operable to provide an O-ring-type seal between the grommet 200 and the housing 18, 108.

The body 204 may be a cylindrical body. For example, the body 204 may be formed from a flexible and resilient dielectric material, such as an elastomer (e.g., rubber or polypropylene) or a thermoplastic sealing material (e.g., polyvinyl chloride (PVC)). The body 204 may include a large diameter portion 212 and a small diameter portion 216. The large diameter portion 212 may include longitudinal apertures 220 that house the sensor lead wires 30, 120. The small diameter portion 216 may house the sensing element lead wires 26, 116 or both the sensing element lead wires 26, 116 and the sensing element 22, 112.

The protrusion 208 may be a ring-shaped and disposed around a circumference of the body 204. For example, the protrusion 208 may be disposed about the small diameter portion 216, the large diameter portion 212, or both the small diameter portion 216 and the large diameter portion 212. When the protrusion 208 is disposed on both the small diameter portion 216 and the large diameter portion 212, the protrusions 208 may be sized differently, with a larger diameter protrusion on the small diameter portion 216 and a smaller diameter protrusion on the large diameter portion 212 so that the outer diameters of both protrusions 208 are, at least approximately, the same. When the grommet 200 is assembled in the housing 18, 108, the protrusion 208 may engage and be deformed by the housing 18, 108. The protrusions 208 may be similar to the protrusions 140, previously described.

The protrusion 208 may be integrally and monolithically formed with the body 204. Alternatively, the protrusion 208 may be a separate part formed of an elastomer, but may be disposed on a surface of the body 204 or in a channel formed on the body 204. By forming the body 204 and protrusion 208 from a flexible and resilient material, the protrusion 208 is able to deform when assembled in the cover 18, 108. As previously described, protrusion 208 can form a circumferential compression seal 208a between the housing 18, 108 and the grommet 200 to help seal, isolate and protect the sensing element 112 and the sensing element lead wires 116 from the ambient environment and inhibit or prevent dirt, debris, moisture, etc., from infiltrating into the sensor 10, 100.

Referring to FIG. 6, a cross-sectional view showing an alternative embodiment of a grommet 133. In some embodiments, the exterior surface 135 of the grommet 133 may, additionally or alternatively, include one or more radially or outwardly protruding longitudinal projections or guide rails 164. The guide rails 164 can intermittently or continuously extend linearly on the exterior surface 135 parallel to a longitudinal axis of the grommet 133 and along a portion or the entirety of the length of the grommet 133. The rails 164 can cooperate with and/or be received in corresponding and/or mating channels or detents included in or on or along an interior surface of the housing 108. The guide rails 164 and channels can serve to rotationally position and/or orient the grommet 133 and probe 104 subassembly within the housing 108 and/or guide the grommet 133 and probe 104 subassembly into the housing 108, such as during manufacture of the sensor 100.

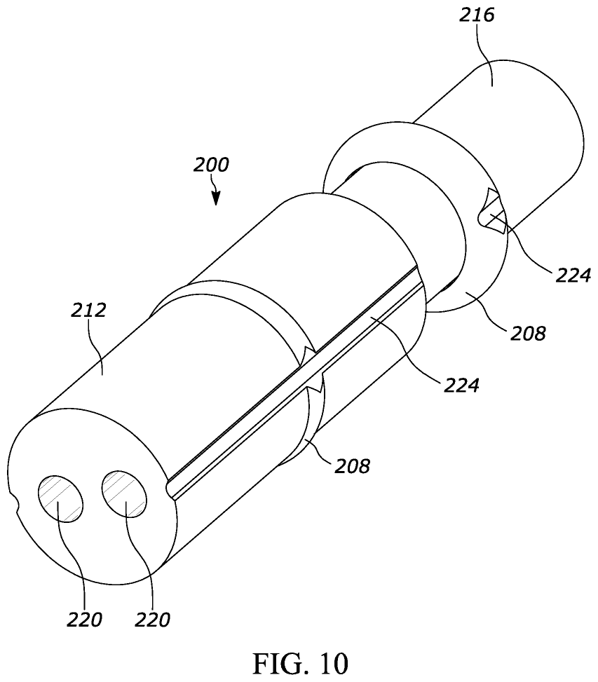

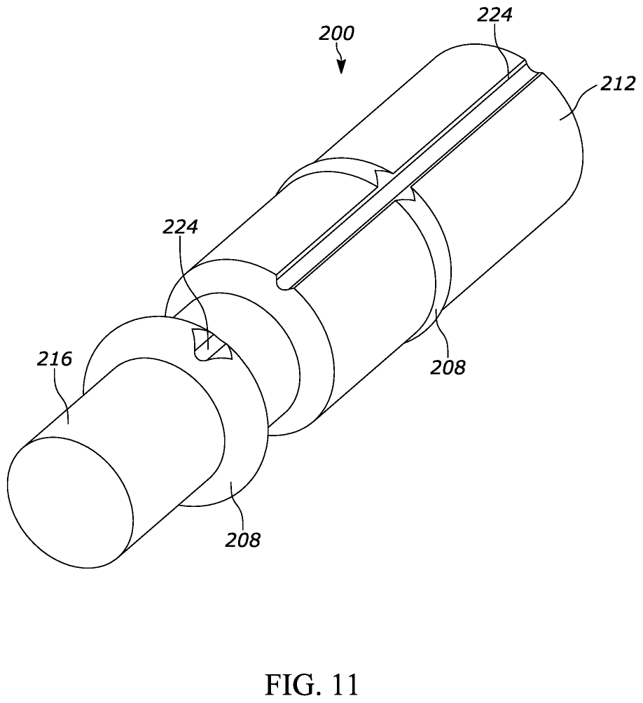

Similarly as described above, and with reference to FIGS. 10 and 11, the grommet 200 may alternatively incorporate grooves or channels 224 in the exterior surface 225 of the grommet 200 and the housing 108 may include corresponding and/or mating projections or guide rails on or along an interior surface of the side wall of the housing 108 that may be pre-formed or formed during mechanical deformation of the housing 108.

17. The temperature sensor of claim 16 wherein one of the outer surface of the grommet and an inner surface of the side wall comprises a plurality of longitudinally extending linear guide rails spaced apart from one another;

wherein the other of the outer surface of the grommet and the inner surface of the side wall comprises a corresponding plurality of longitudinally extending linear grooves spaced apart from one another; and

wherein each of the guide rails is received in a corresponding one of the grooves.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A temperature sensor comprising:
a housing comprising a deformable tubular shell having a closed distal end, an open proximal end and a side wall, and defining an interior cavity;
a temperature responsive sensing element comprising first and second sensing element lead wires;
first and second sensor lead wires, each electrically connected in series to a respective one of the first and second sensing element lead wires at respective first and second connections;
a grommet comprising a flexible and resilient dielectric material and having an outer annular surface;
wherein the grommet, the sensing element, the first and second sensing element lead wires, and the first and second connections are disposed in the interior cavity of the housing; and
wherein the side wall of the housing is mechanically interlocked to the grommet at the outer surface of the grommet to seal the sensing element and sensing element lead wires from an ambient environment outside the interior cavity of the housing.

2. The temperature sensor of claim 1 wherein the side wall of the housing comprises a roll-form crimp that locally deforms the outer surface of the grommet and creates a circumferential compression seal between the housing and the grommet that isolates the sensing element and the sensing element lead wires from the ambient environment.

3. The temperature sensor of claim 1 wherein the first connection and the second connection are disposed in a staggered relationship to one another.

4. The temperature sensor of claim 3 wherein the first and second connections are encapsulated by the grommet.

5. The temperature sensor of claim 4 wherein the grommet comprises a void; and
wherein the void is located between the first connection and the second connection.

6. The temperature sensor of claim 1 wherein the outer surface of the grommet comprises a plurality of annular protrusions spaced apart from one another along a longitudinal axis of the grommet, wherein an outer dimension of each of the protrusions is greater than an inner dimension of the side wall.

7. The temperature sensor of claim 1 wherein at least a portion of the first and second sensing element lead wires and the first and second sensor lead wires are encapsulated by the grommet.

8. The temperature sensor of claim 1 wherein the housing comprises an inwardly directed flange at the proximal end of the housing; and
wherein the inwardly directed flange abuts an end of the grommet.

9. The temperature sensor of claim 8 wherein inwardly directed flange retains the grommet with the housing.

10. The temperature sensor of claim 1 wherein the sensing element is spaced from the side wall of the housing.

11. The temperature sensor of claim 10 wherein the sensing element is spaced from the distal end of the housing.

12. The temperature sensor of claim 11 further comprising a thermally conductive dielectric epoxy disposed in the interior cavity of the housing near the distal end of the housing and encapsulating the sensing element and at least a portion of the first and second sensing element lead wires.

13. The temperature sensor of claim 10 wherein the sensing element is in direct contact with the distal end of the housing.

14. The temperature sensor of claim 13 wherein each of the first and second sensing element lead wires comprise a loop.

15. The temperature sensor of claim 1 wherein housing comprises an outwardly directed flange forming a circumferential lip at the proximal end of the housing.

16. The temperature sensor of claim 15 wherein the housing comprises a first portion and a second portion;
wherein the first portion of the housing comprises at least one annular channel that extends around a circumference of the side wall;
wherein the housing is mechanically interlocked to the grommet at the at least one annular channel; and
wherein the sensing element is disposed in the second portion of the housing.

17. The temperature sensor of claim 1 wherein the grommet comprises a first portion and a second portion;
wherein the first portion of the grommet comprises a first diameter and a resilient and flexible first annular protrusion;
wherein the second portion of the grommet comprises a second diameter and a resilient and flexible second annular protrusion, wherein the second diameter is less than the first diameter;
wherein both the first annular protrusion and the second annular protrusion have a third diameter that is greater than the first diameter.

18. The temperature sensor of claim 17 wherein one of the outer surface of the grommet and an inner surface of the side wall comprises a plurality of longitudinally extending linear guide rails spaced apart from one another;
wherein the other of the outer surface of the grommet and the inner surface of the side wall comprises a corresponding plurality of longitudinally extending linear grooves spaced apart from one another; and
wherein each of the guide rails is received in a corresponding one of the grooves.
